(19) United States
(12) Patent Application Publication
(10) Pub. No.: US 2002/0120874 A1
(43) Pub. Date: Aug. 29, 2002

(54) Method and system for secure exchange of messages

(76) Inventors: Li Shu, Billerica, MA (US); Dorothy C. Poppe, Medford, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/025,115

(22) Filed: Dec. 19, 2001

Related U.S. Application Data
(60) Provisional application No. 60/258,127, filed on Dec. 22, 2000.

(51) Int. Cl. H04L 9/00

(52) U.S. Cl. 713/201

(57) ABSTRACT

The invention features an apparatus and method for transmitting a file. The apparatus includes a file splitter that splits the file into a plurality of message segments. Each message segment includes an address of the destination. The apparatus also includes a file encapsulator. The file encapsulator encapsulates at least one of the plurality of message segments. The encapsulation conceals the address of the destination during transmission of the at least one encapsulated message segment to one or more trusted nodes. The trusted nodes retransmit the message segments to the destination for reassembly of the file at the destination.

### CROSS-REFERENCE TO RELATED CASE

This claims the benefit of and priority to U.S. Provisional Patent Application Serial No. 60/258,127, filed Dec. 22, 2000, the entirety of which is incorporated herein by reference.

### TECHNICAL FIELD

The invention generally relates to electronic communications, and, more particularly, to security in network-based communications.

### BACKGROUND INFORMATION

Message security is of particular concern in modern, network-based communications. Communications often occur between devices such as computers operating in a non-secure network, such as the Internet. It is generally desirable to protect communications from eavesdropping and tampering.

Generally, three approaches have been used to provide secure communications: a secure network; a secure host with security protocols; and encryption of communications. A secure network typically requires steps be taken to protect the network from intruders. Such steps can include special communications protocols or special hardware, for example, use of a secure, optical network backbone. In such cases, secure communications, if at all possible, are limited to the confines of the secure network.

The secure host approach includes installation of a security protocol on network host computers to monitor network communications. The protocol provides review and control of network communications to guard against theft and tampering. This approach requires the host computers to implement a security protocol that operates at Layer 3 or 4 of the Open Systems Interconnection (OSI) model.

A variety of encryption devices or software tools can protect data communications from theft and tampering. For example, keyed encryption techniques are common. Such techniques typically require that a sender and a recipient of a message share some information regarding an encryption algorithm and encryption/decryption key to enable the recipient to de-encrypt a message.

Message packet headers are particularly vulnerable to tampering because the packet header typically cannot be encrypted. Variants of the above general schemes have been proposed to respond to this problem. Further, message packets can be modified to enable detection of tampering and hence the potential of an altered message packet. Alternatively, a message can be disguised to appear as an ordinary message to fool an eavesdropper. The ordinary appearing message would have a distinct meaning to a recipient based on prior agreement between the sender and the recipient.

The above described approaches to message security are ineffective when a secure network or encryption methods are unavailable or not desired.

### SUMMARY OF THE INVENTION

The invention generally involves secure data transmission over a network. The invention is particularly suited to message transmission over a network that has multiple pathways. Various embodiments of the invention can defeat eavesdroppers wishing to intercept or interfere with a message. A solution is provided for the problem of the publicly visible addresses that are typically associated with transmitted communications.

The invention is suited to protect various types of communications. The communications may be digital electronic communications and may include, for example, messages and data. The communications may be sent via a network in the form of packets. The network may be, for example, a wired, wireless or optical network. In the following discussion, the terms “communication”, “message”, “file” and “data” are all used to express the general idea of information transmitted between parties. The particular form that the information assumes during transmission may be binary, as found in modern digital communications.

Improved security is accomplished by use of one or more trusted intermediaries, i.e. nodes, to relay communications between parties, for example, a source and a destination. The ultimate destination of the communication is generally concealed from all but the intermediary. Thus, an intermediary receives a message or other communication from a source, examines the concealed address of the destination and forwards the communication to the destination.

When the intermediary forwards a communication, the source can be concealed while the destination address of the next trusted intermediary, which may be the final destination of the packet, is now publicly observable. In this manner, an eavesdropper cannot simultaneously discern the source and destination of a communication.

An eavesdropper attempting to intercept a message sent between two parties must therefore overcome multiple difficulties. If an eavesdropper observes transmissions such as data packets leaving a source, it cannot correctly identify the ultimate or real destination of each data packet. If the eavesdropper observes data packets arriving at a destination, it cannot correctly identify the original source of each packet. Thus, an eavesdropper may be impeded from identifying messages sent from a particular original source to a particular final destination.

An intermediary can perform the same function for two-way or multi-party communications. The node can be, for example, a network node. The node can be a computer server or a radio transceiver (e.g. a mobile telephone).

Splitting the message into message segments can make message interception and tampering more difficult. An eavesdropper must then intercept multiple segments to obtain the message, and still will not know the source or the destination. To further complicate interception, the ultimate destination addresses of the segments can be concealed when the segments are transmitted to one or more trusted nodes. An eavesdropper seeking messages or segments addressed to a particular destination may then only perceive the message segments as being addressed to the intermediary, and thus fail to intercept them.

Moreover, increasing the number of pathways used for transmission of message segments or data packets provides additional security. An eavesdropper must then monitor and intercept communications along multiple pathways to attempt to obtain all the message segments required for reconstruction of a message. Message segments can be encrypted to impede an eavesdropper still further.

Accordingly, in a first aspect, the invention features an apparatus for transmitting a file. The file can include data or a message, or both. It can be in binary form, as for a typical computer data file. It can be a file of any form as utilized in electronic, electromagnetic, and optical network-based communications. The apparatus includes a file splitter that splits the file into a plurality of message segments. Each message segment includes an address of the destination.

The term “transmit” as used herein means the directing of a file from any source location to any destination location. The actual transmission of a file may occur via all suitable techniques of file transfer, including, but not limited to, standard file-transfer protocols via an electronic or optical network.

The apparatus also includes a file encapsulator. The file encapsulator encapsulates at least one of the plurality of message segments. The encapsulation conceals the address of the true origin and ultimate destination during transmission of at least one encapsulated message segment to one or more trusted nodes. The trusted nodes may re-encapsulate the message and retransmit the message segments to the destination for reassembly of the file at the final destination.

The file splitter may also include a file converter. The file converter converts the file into N message segments. The file can be reassembled from a subset of any M of the message segments, where N and M are positive integers, and N>M≧1.

The apparatus may further include a file encoder. The file encoder encodes the file prior to splitting of the file by the file splitter.

The file encoder, file encapsulator and file splitter may include, for example, integrated circuits, such as microprocessors. A single integrated circuit or microprocessor may include the file encoder, file encapsulator and file splitter. One or more microprocessors may implement software that enables the functioning of the file encoder, file encapsulator or file splitter. Any of the file encapsulator, the file splitter and the file encoder may be implemented in software, firmware or hardware (e.g. as an application-specific integrated circuit). The software may be designed to run on general-purpose equipment or specialized processors dedicated to the functionality herein described.

In second aspect, the invention involves a method of secure transmission of a file from a source to a destination. The method includes splitting the file into a plurality of message segments. Each message segment includes an address of the destination.

The method further includes encapsulating at least one of the plurality of message segments to conceal the address of the origin and destination. At least one encapsulated message segment is transmitted to one or more trusted nodes. The one or more trusted nodes retransmit at least one message segment to the destination for reassembly of the file at the destination.

The process of splitting the file may include converting the file into N message segments. The N message segments may enable reassembly of the file from a subset of any M of the message segments, where N and M are positive integers, and N>M≧1.

Retransmitting at least one message segment may include transmitting at least M of the N message segments to the destination. The file can be reassembled after at least M of the N message segments arrive at the destination.

Transmitting to one or more trusted nodes may include transmitting more than one message segment via multiple pathways of a communications network. In another embodiment, the method further includes encoding the file. Encoding the file may include enciphering the file.

Encapsulating at least one message segment may include enciphering at least one of the message segments. Encapsulating may further include adding forwarding instructions to the message segment. The forwarding instructions instruct one of the trusted nodes to forward the message segment towards the destination. The forwarding instructions may include the address of the destination. Encapsulating may further include addressing each one of the plurality of message segments to one of the plurality of trusted nodes.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an embodiment of a communication of a message from a source to a destination.

FIG. 2 illustrates an embodiment of a communication of a message that provides improved message security.

FIG. 3 illustrates an embodiment of a method that provides message delivery assurance and security.

FIG. 4 illustrates an embodiment of spatial diversification of message transmission, which transmits split message segments along three paths through a network.

FIG. 5 illustrates an embodiment of reassembly of a message at a destination.

FIG. 6 illustrates an embodiment where obstruction of a single node does not deny message transmission.

FIG. 7 illustrates an embodiment where eavesdropping on a single link provides no information.

FIG. 8 illustrates an embodiment with integration of data encryption into an encoder and a decoder.

FIG. 9 illustrates an embodiment with integration of data encryption into the a splitter and a assembler.

FIG. 10 illustrates an embodiment of an apparatus for transmitting a file via a communications network.

FIG. 11 illustrates an embodiment of N message segment identifiers attached to N message segments.

FIG. 12 illustrates an embodiment of an apparatus for transmitting a file.

FIG. 13 illustrates an embodiment of an encapsulated message segment addressed to a trusted node.

FIG. 14 illustrates an embodiment of a message segment addressed to a destination.

### DESCRIPTION

The terms “file”, “message”, “data” and “data file” are herein understood to refer to any entity of data that may be transferred via analog or digital means. The entity may originate in analog or digital form, and, at various times, may be stored in analog or digital form. The entity is capable of transfer between two distinct physical locations via, in particular, electronic, wireless and optically based communications.

Although, as explained above, the present invention may be applied to any form of data or message, particularly high security can be achieved by splitting a message into multiple segments sent over different network pathways. At the same time, this approach also involves a greater degree of complexity than applications utilizing a single pathway.

Accordingly, for purposes of explanation, an advantageous technique of message splitting for multiple-pathway networks is described below in the section labeled “I”. Then, in the section labeled “II”, further embodiments of the invention are described, which have particular utility in connection with transmission of split messages via a single pathway or via multiple pathways.

I. Message Splitting and Spatially Diversified Message Routing for Increasing Transmission Assurance and Data security Over Distributed Networks

An apparatus and method for data assurance in communication networks makes advantageous use of aspects of networked communication. Though the below discussion is applicable to communication networks generally, several embodiments are given for mobile ad-hoc networks (MANET), since some features are preferably applied to MANETs.

During a typical communications session (between, e.g., an originating node and a destination node), messages can be forwarded along multiple, variable data paths. Aggregation of a number of such paths forms a single “super path.” In one embodiment, a method includes encoding a message, splitting the encoded result into distinct message segments, and sending each segment along a different path. A receiving node may reconstruct the original message without the requirement that all message segments eventually reach the receiving node after traveling along their individual paths.

One embodiment includes a protocol that enables a sender to provide information to a destination, i.e., receiver node, about encoding and splitting algorithms that were used to process a message. Some embodiments include methods for inferring the status of the collection of links. Some embodiments include one or more algorithms for determining which combination of encoding and splitting algorithms to use in response to a current status of the links.

Hence, some embodiments enable dynamic adjustment in response to changing network communication conditions, in particular for a MANET. One such embodiment includes a set of encoding/decoding algorithms and a set of splitting/reassembling algorithms to permit an optimized response to the dynamic variations in the link characteristics. Modified algorithms can incorporate data security enhancement features.

For example, encoding algorithms may be used to prevent the deduction of any part of the original message from individual processed message segments. A minimum number of message segments may be required to reconstruct the original message. Further, encryption keys may be used to enhance security. In particular, security enhancement can be achieved by deterministically varying a set of splitting/reassembling algorithms.

Data assurance in networks can be adjusted to a desired level by choosing an appropriate encoding and splitting scheme to tolerate failures over a sufficiently large number of paths. Encoding redundancy can reduce or eliminate the need for message retransmission. Message delay may be reduced, and utilization of each link in the network may be increased. Generally, the benefit in overall network resource utilization and performance grows with the number of links, i.e., the number of directly communicating nodepair combinations, and the expected number of relaying hops through which a packet is forwarded towards its destination.

In one aspect, the apparatus and method improve data security. As multiple message segments are required to decode the original message, an eavesdropper sniffing, e.g., packets traveling on a particular path cannot deduce much useful information. Additional security components or steps can improve the level of data security; for example, encoding mechanisms can be chosen to avoid exposing the original data bits directly and a bit-position scrambling mechanism can be incorporated before splitting of the message. This provides security gains that require almost no increase in system complexity or computational burden.

In one embodiment, a redundantly encoded message is transmitted by aggregating multiple paths in a MANET to form a single super-path. This aggregation provides robustness in view of the potentially drastic variation in individual links. The super-path has a collective characteristic that improves stability, and statistically resembles a fixed link pathway in comparison to a pathway through a conventional MANET.

The channel coding technique may first encode the message to inject the desired level of redundancy into the message, then split the encoded message into multiple segments, and then forward each segment along a different path. At the receiving end, the extra redundancy injected by the encoding method (via, e.g., erasure correcting codes) may permit reassembly of the original message without requiring the successful delivery of all message segments through their individual paths.

Encoding methods may be used to improve the data assurance to a desired level for a network, or example, a MANET. This is more effective for MANET-based communications than simply adopting or adapting the two-pronged approach of fixed point-to-point channels (and conventional networks). The characteristics of the aggregated super-path more closely resemble that of the fixed point-to-point channel than that of the individual member paths in the aggregate. Moreover, the variation in the characteristics of the super-path is slower than the variation of individual member paths, and can be designed to become tractable.

As a result, the variation of super-path characteristics can become more sensitive to network communications congestion than to link-to-link communication variations, e.g., radio frequency channel variations, arising from movement of the nodes. Hence, in one embodiment, super-path characteristics are regularly or continuously analyzed, and encoding and splitting algorithms are selected from classes of encoding algorithms and splitting algorithms in response to a determined characteristic. Super-path characteristics may include, for example, the number of successfully received message segments and the identity of the paths through which message segments are successfully received.

The performance of these classes of algorithms can be rated. Protocols that implement measurement of super-path characteristics and dynamic selection of an optimum combination of encoding algorithms and splitting algorithms can also be rated. Rating of algorithms and protocols can permit improved optimization of selections.

Encoding and splitting of messages directly improves message security. Because the message segments are forwarded along distinct routes to the destination, an eavesdropper must simultaneously intercept multiple message segments before a successful recovery of the original message becomes possible. The mobility and the geographical distribution of the nodes in the network make this difficult, and splitting the message into more segments can increase the difficulty of recovery. Furthermore, an encoding algorithm can be chosen that prevents message reconstruction without interception of at least a threshold portion of message segments.

Additional security is made possible by scrambling, even simple scrambling, of the positions of the encoded message bits, e.g. before splitting, to prevent message reconstruction by an eavesdropper even when the eavesdropper intercepts a sufficiently large number of message segments. Generally, scrambling and de-scrambling of bit positions requires many fewer operations to execute and complete than traditional encryption and decryption methods.

Some embodiments include a stand-alone protocol layer for insertion in the networking protocol layer. For example, the protocol layer can be inserted between the medium access control (MAC) layer and the networking layer of a communication system. The protocol layer may include mechanisms for monitoring or analyzing the characteristics of network links and a decision algorithm to dynamically choose one of a class of encoding and splitting algorithms based on the observed network link characteristics.

In one embodiment, when the link stability is low, the protocol layer switches to an encoding algorithm that tolerates more losses of the message segments and a message-splitting scheme that results in smaller segments, in an attempt to improve delivery assurance. In another embodiment, when the link stability improves, the protocol layer switches to an encoding algorithm that has requires more message segments to be received and a message-splitting scheme that uses larger segments, in an attempt to reduce the protocol overhead.

The impact of the proposed algorithm and the dynamic protocol can be measured at multiple levels of the network. The probability of delivery success in a single attempt can be improved to any desired level by choosing an appropriate combination of encoding and splitting methods or algorithms. Generally, an entire message is not transmitted along a single path. Instead, a message is fragmented, i.e. split, and forwarded along multiple paths. The realized increase in data assurance general comes with an initial delay in transmission of message segments, or packets, due to the encoding and splitting. Generally, however, overall communications delays are improved because of the improved probability of completion of each message transmission in the first attempt.

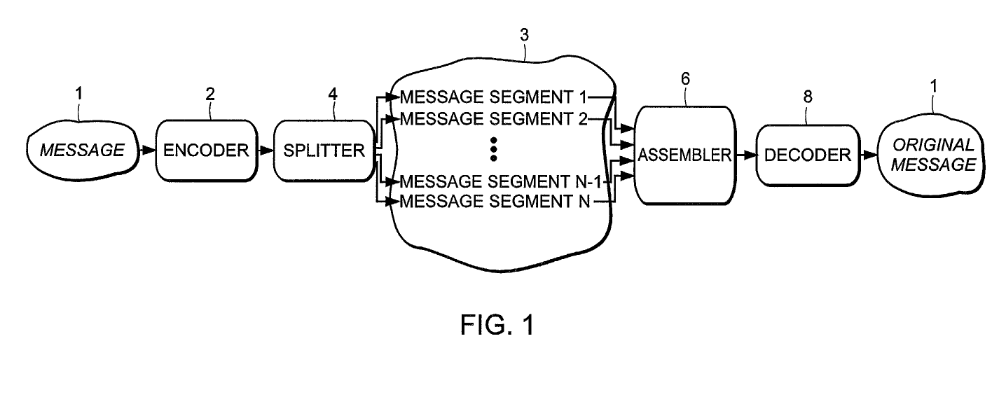

Referring to FIG. 1, an embodiment of a communication of a message from a source to a destination is illustrated. A message 1, e.g., a block of message bits, is fed to an encoder 2, e.g. a scrambling encoder. The encoder 2 injects redundancy into the message bit stream, which increases the number of bits in the message. The encoded message is fed to a message splitter 4, which breaks the message into N message segments.

The N message segments are forwarded to the destination along different paths in a network 3. An assembler 6 reassembles the encoded message as the segments are received. When the number of segments received reaches a specified threshold, a partially reassembled message is passed to a decoder 8, e.g. an erasure decoder. The decoder recovers the original message 1, using only the bits available from the partially assembled message. The threshold number of segments is determined by the selected coding scheme. Both the assembler 6 and the erasure decoder 8 may be implemented in hardware and/or as software modules.

Improving the probability of completed delivery of a message in a first attempt reduces both the average delay and the number of retransmissions required for deliver of messages through the network. Reducing the number of retransmissions decreases the number of channel contentions in a network with multi-accessing nodes such as a MANET. This may significantly improve the utilization of both the links and the network, in terms of factors such as the number of data bits sent per usage of bandwidth, channel, link, battery power, etc. This in turn significantly improves the overall network throughput and efficiency.

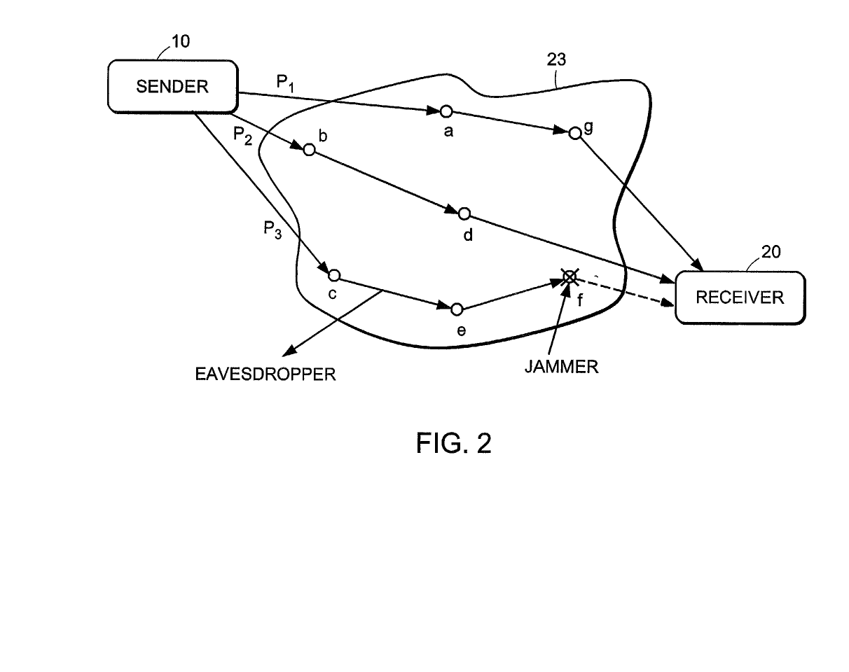

FIG. 2 illustrates an embodiment that provides improved message security. A sender 10 and a receiver 20 agree to use a combination of an encoding scheme and a splitting mechanism that splits each message into three segments for transmission via a MANET 23. The MANET 23 includes several nodes a-g. The encoding scheme requires at least two message segments to reach the receiver for recovery of a split message. An eavesdropper is illustrated as intercepting message segments between nodes c and e; a jammer is illustrated as blocking transmission of message segments at node f. Three paths P₁, P₂, P₃ through the network 23 are a subset of all possible paths. Message security and integrity are maintained in spite of the efforts of the eavesdropper and the jammer.

The eavesdropper acquires only a message segment transmitted along path P₃. Because the number of message segments threshold is 2, the single segment does not provide any useful information to the eavesdropper. All three segments will reach the receiver 20. The first two to arrive are used to reassemble the original message.

The jammer attacking node f prevents the message segment traveling on path P₃ from reaching the receiver 20. The other two message segments, however, arrive, and the message is recovered. The jammer cannot prevent the receiver 20 from getting the message.

Several criteria may be used to assess the performance of alternative implementations of a decision algorithm and a dynamic protocol. Such criteria may include, for example:

delivery assurance, the probability of successful receipt of a fully correct message (affected by the probability of link/node failure);

security improvement, in terms of the number of message segments that must be acquired by an eavesdropper in order to reconstruct the original message; and

improvement in effective bandwidth, the reduction in the number of required retransmissions as compared to, for example, the adaptation of the two-pronged approach to a MANET.

In one embodiment, a protocol is inserted into a network communications protocol stack, e.g., between the MAC and the networking layer. This protocol mechanism senses and predicts variations in the characteristics of the link aggregate, and dynamically chooses the best combination of encoding/decoding and splitting/reassembly algorithms from a set or class of algorithms. The attempt to optimize can seek a combination that adds the least overhead to achieve a specified probability of successful message delivery. The selection process may further include, e.g., consideration of message priority, other measures of message importance, or cost of latency.

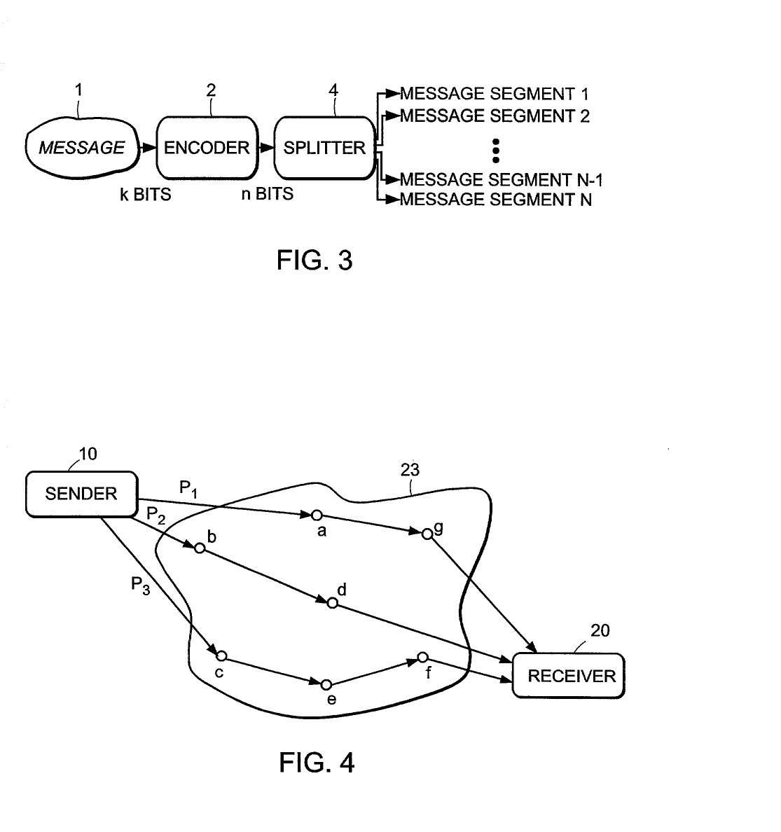

Referring to FIG. 3, one embodiment is illustrated of a method that provides message delivery assurance and security. The method includes encoding the message to inject redundancy into a message stream, and splitting the encoded message. The split, encoded message is forwarded along spatially diversified routes.

For example, a message, or message block, that includes k bits is processed through an encoder 2, e.g., a scrambling encoder, that converts the message into an encoded message block of n bits, where n>k. A splitter 4 decomposes the output of the encoder 2 into N message segments, each segment including no more than [n/N] bits. “[n/N]” denotes the least integer greater than n/N. N, n and k are positive integers.

FIG. 4 illustrates spatial diversification. Each of the N message segments is forwarded to the intended recipient, preferably along a different route. This gives spatial diversification to the routes used for transmission. Nodes a-g are a subset of network 23 nodes. The sender 10 forwards segments to the receiver 20 along path P₁ (including nodes a and g), path P₂ (including nodes b and d), and path P₃ (nodes c, e, and f). The different physical locations of the nodes forces the message segments to travel through different areas of the network. Link conditions and congestion in different areas may vary considerably.

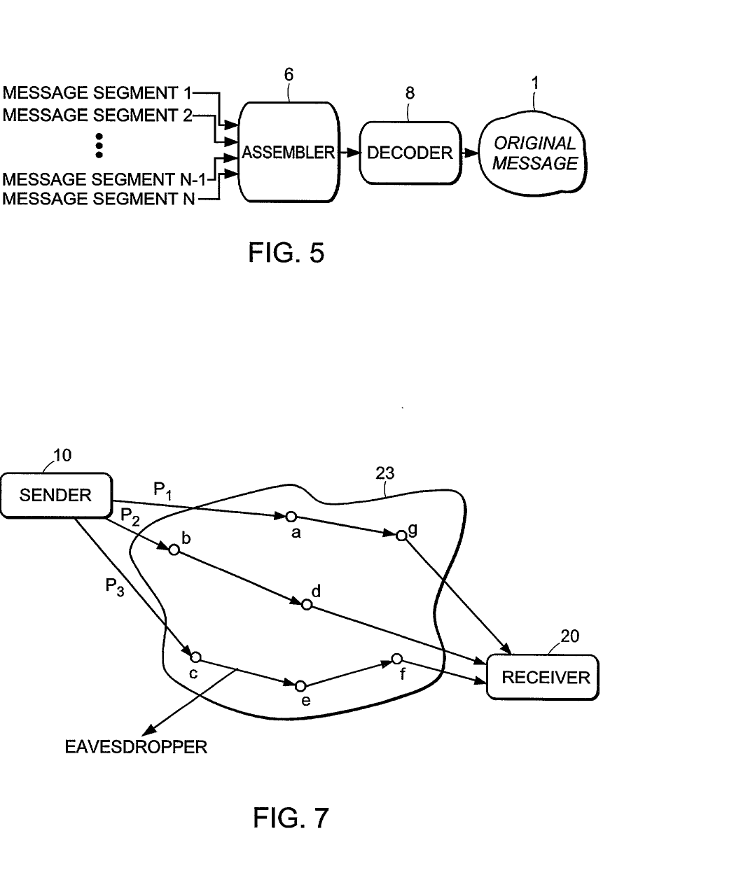

Referring to FIG. 5, the message segments are re-assembled as they are received at the receiver 20. When a sufficiently large number of message segments is received, the partially assembled message is forwarded to a decoder 8, e.g., an erasure decoder, which recovers the entire original message. Improved delivery assurance is achieved because not all message segments must be successfully received to permit the recipient to recover the original message.

In one embodiment, each message segment has a length of b, where 0<b≦[n/N]. “[n/N]” denotes the least integer greater than n/N. Limitation of the value of b can assure that each encoded message bit exists in only one message segment. Because n must be greater than k, [k/b]<N. Hence, there are fewer than N segments when the shorter unencoded message is broken into segments of length b. A longer, encoded message is obtained with N segments of length b.

The intended recipient can recover the original message with any subset of [k/b] segments of the N message segments, given an appropriate selection of the encoding scheme. Hence, the message recovery mechanism at the intended recipient can tolerate the loss of some of the message segments. This allows for losses due to, e.g., network congestion, broken links, interference or jamming. This may require n bits to be transmitted for every k message bits, where n>k. Advantages are realized, however, such as:

n/k may be smaller than the number of bits that would be transmitted for each bit if an entire block is retransmitted; and

the probability that the intended recipient correctly recovers the original message from a single transmission attempt is improved.

Examples of classes of error-correcting codes that can be utilized include Bose-Chaudhuri-Hocquenghem (BCH) codes, Convolutional codes, Hamming codes, Reed-Solomon codes, Golay codes, Turbo codes, and several other linear and nonlinear block codes.

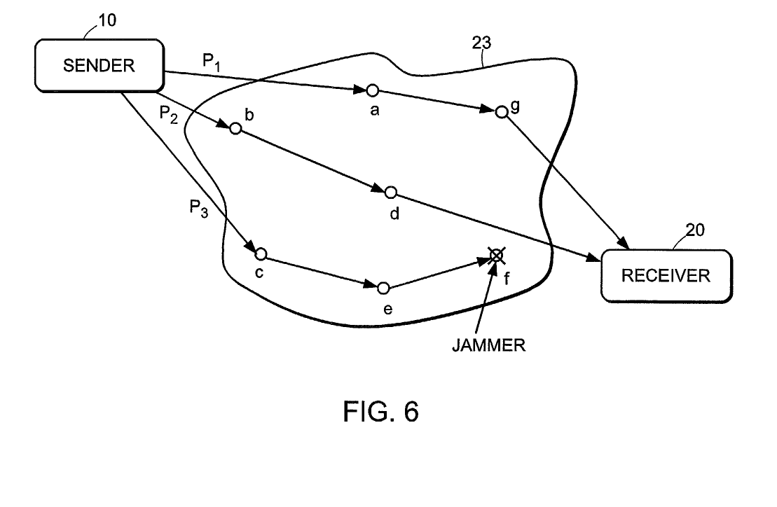

Various embodiments provide significant security benefits. Referring to FIG. 6, resistance to localized jamming is one benefit. Jamming, for example, disrupting transmission at a single network node or link, minimally impacts the functionality of the rest of the network. When a jammer located near node f has broken the continuity of path P₃, path P₁ and path P₂ are still able to deliver message segments, and the message is successfully decoded. To be effective at disruption, a jammer must be located close enough to either the sender 10 or receiver 20 to jam a significant number of message segments. For example, the probability of disruption in a mobile, military network is reduced by the requirement for close proximity of a hostile jammer.

Referring to FIG. 7, another security benefit of some embodiments is the difficulty an eavesdropper experiences when trying to intercept messages. As illustrated in FIG. 7, an eavesdropper is physically located between node c and node e, able to copy any message segment, e.g., data packet, that passes along path P₃. The eavesdropper must correctly receive a minimum of [k/b] message segments to recover a complete message. To receive the minimum number of segments, however, requires eavesdropping on other paths P₁, P₂.

Some embodiments prevent even partial message recovery by the eavesdropper. An appropriately chosen scrambling encoder (e.g., a non-systematic code) can be used to create a condition during which any subset of q message segments, with q<[k/b], will prove insufficient to recover any subset of the original message. Similar to the jammer, the eavesdropper must be physically located very close to either the sender 10 or the intended recipient 20 to effectively intercept segments from multiple paths P₁, P₂, P₃.

The effectiveness of a local jammer is reduced by taking advantage of the nature of a distributed networking environment. Similarly, a single eavesdropper has a reduced ability to observe enough segments to allow an understanding of the communications carried by the network. As a result, the overall security of information carried by the entire network is significantly improved.

Some embodiments further improve security through use of data encryption by means of bit position scrambling. The selection of a scrambling encoder can be controlled with an encryption key. In some alternative embodiments, the actual bit scrambling can be accomplished in either an encoder or a splitter.

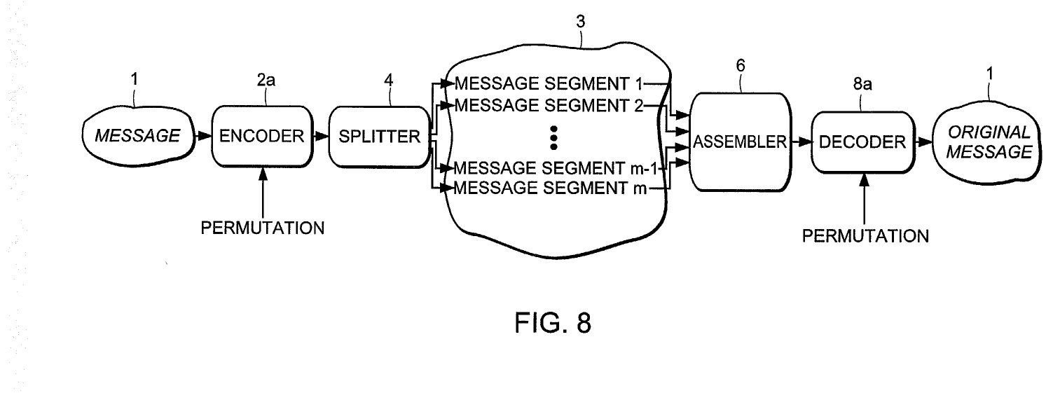

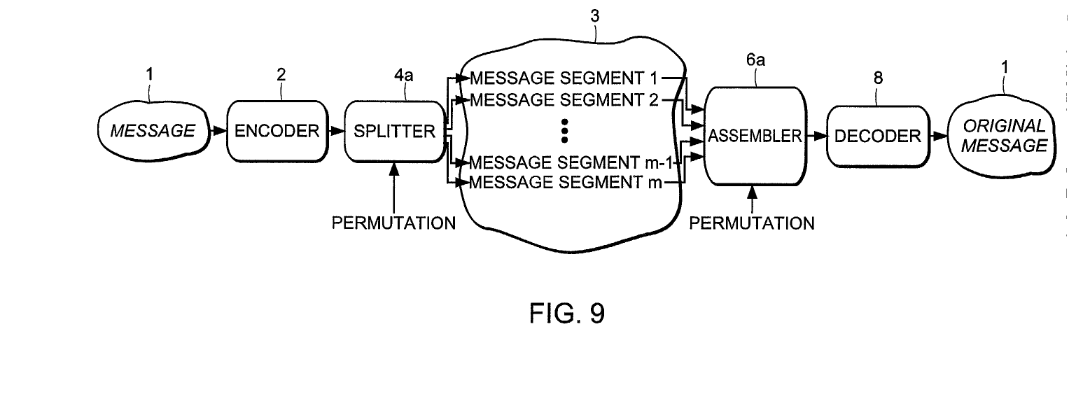

Referring to FIGS. 8 and 9, embodiments that utilize permutation are illustrated. FIG. 8 schematically shows the use of permutation by an encoder 2a. FIG. 9 shows the use of permutation by a splitter 4a. For example, even a simple use of an encryption key to alter bit positions in the encoded message, would require the eavesdropper to potentially search through n! possibilities.

Some embodiments that include a scrambling encoder employ an encoding scheme that provides one or both of the following features:

the encoding scheme provides strong resilience against loss of message segments, preferably having the value of (k+e) as close to n as possible, where e is the number of message segment losses that the scheme can overcome, k is the original message length, and n is the encoded message length; and no bits in the original message are ascertainable from any message subset below a threshold number; for linear block codes, this generally requires use of nonsystematic codes and that approximately half of the elements of a generating matrix elements have a value of 1.

In order for the assembler at the receiving node to correctly reassemble the message fragments, the content of each segment must be identified. In one embodiment, the information required for reassembly is reduced by inclusion of a numbering scheme for the message segments. In a preferred embodiment, a segment carries identification that is a number assigned by the message splitter. This number may be a field in a protocol header that is attached to each message segment, or embedded in the message segment itself.

Additional protocol header fields may be included when encoding and splitting algorithms are altered dynamically to better suit the observed characteristic variations of the super-path. The additional fields can carry measurement data regarding the characteristics of the super-path as well as data that informs the destination node of the changes in the encoding and splitting algorithms. Inclusion of additional protocol header fields incurs additional transmission bandwidth for every hop. Hence, it is preferable to optimize choices of fields to minimize the resulting bandwidth expansion.

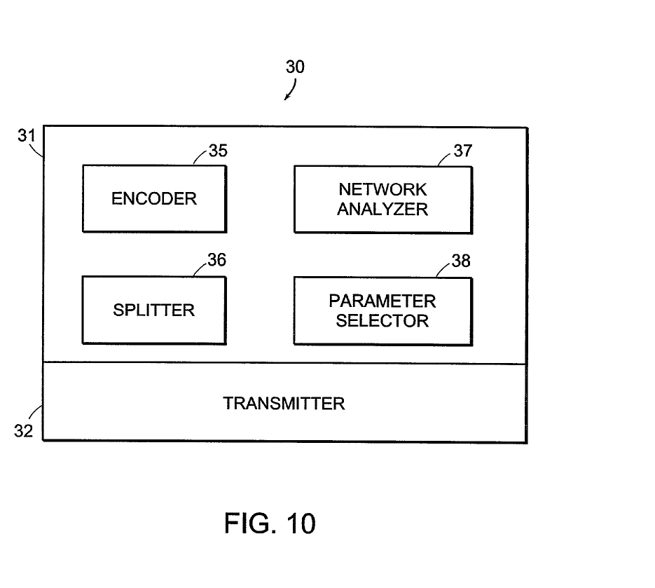

Referring to FIG. 10, an embodiment of an apparatus 30 for transmitting a file via a communications network is illustrated. The apparatus 30 includes a file processor 31, which may be implemented in hardware and/or as a software module, and a message segment transmitter 32. The file processor converts files into N message segments that enable reassembly of the file from a subset of any M of the message segments. N and M are positive integers and N>M≧1.

The message segment transmitter 32, which may be implemented in hardware and/or as a software module, transmits message segments to a receiver. The receiver can reassemble a file after receiving M of the N message segments.

The file processor 31 may comprise a file encoder 35 and an encoded file splitter 36 that convert a file into N message segments. The file encoder 35 may implement a class of encoding algorithms in generating the message segments. The encoded file splitter 36 may implement a class of splitting algorithms.

The processor 31 may further comprise a communications network analyzer 37, which may be implemented in hardware and/or as a software module, that determines the condition of a communications network. The processor 31 may also include a message segment parameter selector 38 (which also may be implemented in hardware and/or as a software module) that selects a set of values for M and N based on the determined condition to achieve a preselected probability of a successful transmission of M of the transmitted message segments.

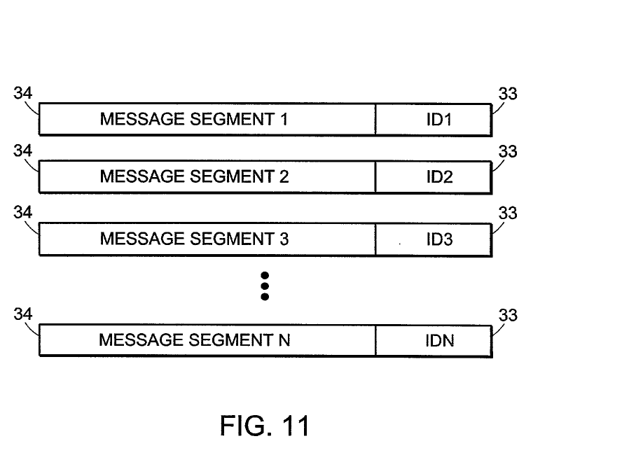

Referring to FIG. 11, the apparatus may include N message segment identifiers 33 that have a one-to-one association with the N message segments 34. In the embodiment illustrated in FIG. 11, message segments 34 are transmitted with their associated identifiers 33 to assist in reassembly of the message. The identifiers 33 can include, for example alphanumeric data. In one embodiment, during transmission, the identifiers 33 are binary numbers.

The above described and various other embodiments are of particular value when applied, for example, to ad-hoc networks, MANETs and conventional packet networks with distributed routing algorithms. Particular value accrues when applied to MANETs that include moderately mobile units.

II. Method and System for Secure Exchange of Messages

The security of information carried by a network may be improved when a sender and recipient utilize a trusted node as an intermediary for exchange of communications. A trusted node may be selected for its ability to securely and reliably forward communications, such as messages, message segments and storage segments. For example, rather than addressing every message segment to an intended recipient, a message sender may address one or more of the message segments to one or more trusted nodes. In preferred embodiments, forwarding instructions are included with the message segments to enable forwarding of the segments to the intended recipient.

Various embodiments may be used to obscure the origin and destination of a message. Message interception is very difficult for an eavesdropper tapping a communication link, even if the link is in close proximity to either the sender or recipient. To deduce the messages of a particular conversation, all messages or message segments received by, or leaving, the recipient (who may also be a sender) must be captured. Further, some or all of the communications may be encrypted to further complicate the eavesdropper's task. Increasing the number of trusted nodes can dramatically increase the difficulty of message interception.

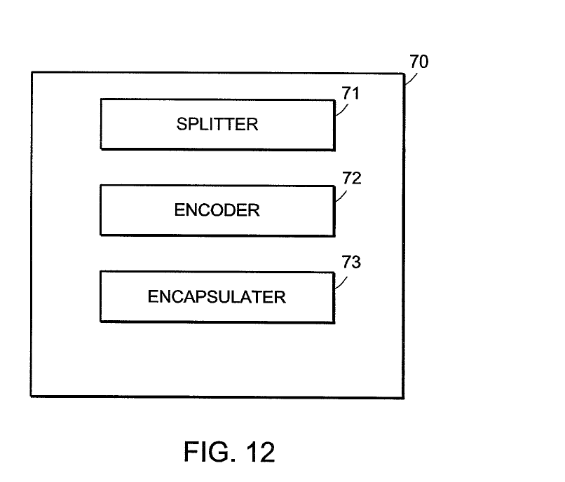

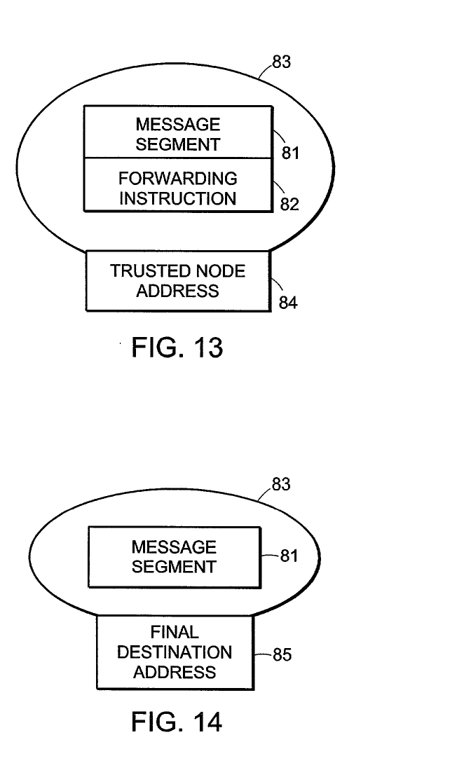

Referring to FIGS. 12-14, one embodiment of an apparatus for transmitting a file includes a file splitter 71 that splits the file into a plurality of message segments 81. Each message segment includes forwarding instructions 82, e.g., an address of the destination. The transmission of message segments 81 may occur via all suitable techniques of file transfer, including, but not limited to, standard file-transfer protocols via an electronic or optical network.

The apparatus also includes a file encapsulator 73. The file encapsulator 73 encapsulates at least one of the plurality of message segments 81. The encapsulation 83 conceals the address of the destination during transmission of the encapsulated message segment 81 to one or more trusted nodes.

A trusted node address 84, which is publicly visible, is attached to the encapsulated message segment 81 to permit transmission of the message segment 81 to the corresponding trusted node. The trusted node re-encapsulates and retransmits the message segment 81, in part by examining the forwarding instructions 82 and making the address of the next destination, which may be the final destination address 85, visible to the network.

The file splitter 71 may also include a file converter. The file converter converts the file into N message segments that permit reassembly of the file from a subset of any M of the message segments, where N and M are positive integers, and N>M ≧1.

The apparatus may further include a file encoder 72. The file encoder 72 encodes the file prior to splitting of the file by the file splitter 71.

The file encoder 72, file encapsulator 73 and file splitter 71 may include, for example, integrated circuits, such as microprocessors. A single integrated circuit or microprocessor may include the file encoder 72, file encapsulator 73 and file splitter 71. One or more microprocessors may implement software that enables the functioning of the file encoder 72, file encapsulator 73 or file splitter 71. Any of the file encapsulator 73, the file splitter 71 and the file encoder 72 may be implemented in software, firmware or hardware (e.g. as an application-specific integrated circuit). The software may be designed to run on general-purpose equipment or specialized processors dedicated to the functionality herein described.

An embodiment of a method of secure transmission of a file from a source to a destination includes splitting the file into a plurality of message segments. Each message segment includes an address of the destination. The method may further include encoding the file. Encoding the file may include enciphering the file.

The process of splitting the file may include converting the file into N message segments. The N message segments may enable reassembly of the file from a subset of any M of the message segments, where N and M are positive integers, and N>M ≧1.

The method also includes encapsulating at least one of the plurality of message segments to conceal the address of the destination. At least one encapsulated message segment is transmitted to one or more trusted nodes. Message segments may be transmitted via multiple pathways of a communications network.

The one or more trusted nodes retransmit the message segment to the destination for reassembly of the file at the destination. Retransmitting at least one message segment may include transmitting at least M of the N message segments to the destination. The message segment may be encapsulated during transmission from the trusted node to another trusted node or to the destination. The file can be reassembled after at least M of the N message segments arrive at the destination.

Encapsulating a message segment may include enciphering the message segments. Encapsulating may further include adding forwarding instructions to the message segment. The forwarding instructions instruct a receiving one of the trusted nodes to forward the message segment toward the destination. The forwarding instructions may include the address of the destination. Encapsulating may further include addressing each one of the plurality of message segments to one of the plurality of trusted nodes.

Some embodiments of a method of secure transmission of a file from a source to a destination include two or more stages of file splitting. In these embodiments, one or more message segments from a first file splitting step may be further split into additional message segments. A second splitting step may be advantageous, for example, when a node that transmits files via a network has limited access to the network. For example, a node that transmits files via the Internet may have limited gateway access. The access may be limited, for example, to as few as one or two gateways.

The node might then split a file into a few message segments, for example three message segments, and transmit the message segments to the gateways. The gateways could further split one or more of the three message segments, and then forward message segments toward a destination via the Internet.

In some embodiments of a method, which include multiple splitting steps, the file is converted into N message segments that enable reassembly of the file from a subset of any M of the message segments. At least M of the N message segments are transmitted toward a destination for reassembly of the file after receiving M of the N message segments.

At least one of the transmitted segments is further converted into N₂ message segments that enable reassembly of the at least one message segment from a subset of any M₂ Of the N₂ message segments, where N₂ and M₂ are positive integers and N₂>M₂≧1. At least M₂ of the N₂ message segments are transmitted toward the destination for reassembly of the at least one message segment prior to reassembly of the file.

The at least M₂ segments may be reassembled at the destination. Alternatively, the at least M₂ segments may be received and reassembled by an intermediate node. The reassembled segment may then be transmitted toward the final destination. Additional conversion steps and/or reassembly steps may be included at intermediate nodes in the network.

Various embodiments of the method and apparatus for secure exchange of messages may be applied to network-based communications. Relevant networks include, but are not limited to, local-area networks (LAN) or a wide area networks (WAN) such as the Internet or the World Wide Web. Senders and receivers can be connected to a WAN either directly or via a LAN through a variety of connections including standard telephone lines, LAN or WAN links (e.g., T1, T3, 56 kb, X.25), broadband connections (ISDN, DSL, Frame Relay, ATM), and wireless connections. The connections can be established using a variety of communication protocols (e.g., TCP/IP, IPX, SPX, NetBIOS, Ethernet, RS232, and direct asynchronous connections).

In some embodiments, the sender and receiver are comprised of appropriate computer hardware. Examples of such hardware include any personal computer (e.g., Windows or Macintosh operating system computer), Windows-based terminal, Network Computer, wireless device, information appliance, RISC Power PC device, X-device, workstation, mini computer, main frame computer or other computing device.

Alternatively, the sender or receiver can be a portable computing device such as a PDA or cell phone. As a further alternative, the sender or receiver can be any terminal (windows or non-windows based), or thin-client device operating according to a server-based computing model.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. An apparatus for transmitting a file, comprising:
a file splitter that splits the file into a plurality of message segments, each message segment including an address of the destination; and
a file encapsulator that encapsulates at least one of the plurality of message segments to conceal the address of the destination during transmission of at least one encapsulated message segment to one or more trusted nodes for retransmission by the one or more trusted nodes toward the destination for reassembly of the file at the destination.

2. The apparatus of claim 1 wherein the file splitter comprises a file converter that converts the file into N message segments that enable reassembly of the file from a subset of any M of the message segments, where N and M are positive integers, and N>M≧1.

3. The apparatus of claim 1 wherein a single processor includes the file splitter and the file encapsulator.

4. The apparatus of claim 1 further comprising a file encoder that encodes the file prior to splitting of the file by the file splitter.

5. A method of secure transmission of a file from a source to a destination, comprising the steps of:
splitting the file into a plurality of message segments, each message segment including an address of the destination;
encapsulating at least one of the plurality of message segments to conceal the address of the destination;
transmitting at least one encapsulated message segment to one or more trusted nodes; and
causing retransmission of the at least one of the plurality of message segments from the one or more trusted nodes toward the destination for reassembly of the file at the destination.

6. The method claim 5 wherein the step of splitting the file comprises the step of converting the file into N message segments that enable reassembly of the file from a subset of any M of the message segments, where N and M are positive integers, and N>M≧1.

7. The method of claim 6 wherein the step of causing retransmission comprises causing splitting of the at least one message segment into N₂ message segments that enable reassembly of the at least one message segment from a subset of any M₂ of the N₂ message segments, where N₂ and M₂ are positive integers and N₂>M₂ ≧1; and causing transmission of at least M₂ of the N₂ message segments toward the destination for reassembly of the at least one message segment prior to reassembly of the file.

8. The method of claim 6 wherein the step of causing retransmission comprises the step of transmitting at least M of the N message segments to the destination for reassembly of the file after at least M of the N message segments arrive at the destination.

9. The method of claim 5 wherein the step of transmitting comprises the step of transmitting more than one message segment via multiple pathways of a communications network.

10. The method of claim 5 further comprising the step of encoding the file prior to transmission.

11. The method of claim 10 wherein the step of encoding the file comprises the step of enciphering the file.

12. The method of claim 5 wherein the step of encapsulating at least one of the plurality of message segments comprises the step of enciphering the at least one of the plurality of message segments.

13. The method of claim 5 wherein the step of encapsulating at least one of the plurality of message segments comprises the step of adding forwarding instructions to at least one of the plurality of message segments to instruct a receiving one of the plurality of trusted nodes to forward at least one of the plurality of message segments toward the destination.

14. The method of claim 5 wherein the step of encapsulating at least one of the plurality of message segments comprises the step of addressing each one of the plurality of message segments to one of the plurality of trusted nodes.

15. The method of claim 5 wherein the step of causing retransmission comprises causing splitting of the at least one of the plurality of message segments into a second plurality of message segments including an address of the destination; and causing transmission of the second plurality of message segments toward the destination.

16. The method of claim 15 further comprising the steps of causing reassembly of the at least one message segment; and causing transmission of the at least one reassembled message segment toward the receiver.
